(19) United States
(12) Patent Application Publication
(10) Pub. No.: US 2006/0227008 A1
(43) Pub. Date: Oct. 12, 2006

(54) Emergency vehicle proximity warning system

(76) Inventor: Jason D. Bryant, Nebo, NC (US)

Correspondence Address: Jason D. Bryant, 110 Rock Cliff Drive, Nebo, NC, 28761, US

(21) Appl. No.: 11/094,762

(22) Filed: Mar. 31, 2005

(51) Int. Cl. G08G 1/00

(52) U.S. Cl. 340/902

(57) ABSTRACT

The invention consists of a radio transmitter located in an emergency vehicle and a receiver located in other vehicles. When the emergency vehicle warning light is on, a low wattage radio transmitter emits a signal which is picked up by a radio receiver in other vehicles in close proximity and causes an audible and/or visual alarm to be activated.

### FIELD OF THE INVENTION

This invention is in the category of Emergency Vehicle Proximity Warning Systems.

### BACKGROUND

It was originally developed by me in 1964 when the introduction of the new quiet interiors of the 1965 Ford cars suggested to me that the driver would have trouble hearing the siren of an emergency vehicle in the vicinity. I contacted Ford Motor Company and described it only as a safety system and they responded saying that since they might be working on a similar system, I should get a patent and then re-contact them. On learning the cost of a Patent Attorney and the application process, I realized that this young college instructor would have to shelve the idea for a while.

Growing congestion on highways, injuries and deaths of law enforcement officers and the need for a proximity warning system other than emergency vehicle lights and sound emitters prompted me to proceed with this application.

### SUMMARY OF THE INVENTION

The invention consists of at least two sub-systems which include a radio transmitter located in an emergency vehicle and a receiver located in other vehicles. When the emergency vehicle warning light is on, a low wattage radio transmitter emits a signal which is picked up by a radio receiver in other vehicles in close proximity and causes an audible and/or visual alarm to be activated if they have their ignitions on.

The objective is to save lives by alerting drivers or others with the receiver to the fact that there is an emergency vehicle traveling or stopped with its “blue” light on nearby. By having a warning signal in the passenger vehicle alert drivers to the close proximity of the emergency vehicle, the police officer who has stopped a vehicle is not as likely to be hit by a passing motorist; other emergency vehicles can proceed more safely by having their presence known; and passengers and pedestrians are less likely to be injured or killed due to an accident involving emergency vehicles.

The receiver/warning device may be stand alone or integrated into items such as but not limited to wristwatches, eyeglasses, headsets, telephones, and other items and may be multiple channel in order to reflect different types of information or warnings transmitted by authorized entities or agencies on those frequencies.

### DETAILED DESCRIPTION OF THE INVENTION

The invention consists of two sub-systems. The first is a low wattage transmitter mounted in an emergency vehicle which operates on a fixed frequency, assigned or unassigned depending on the ruling of the FCC, and which emits a signal when it is turned on. In the most simple version, the transmitter would be turned on when the emergency warning light is activated in the emergency vehicle.

The second sub-system is a receiver mounted in a passenger car or other vehicle which is turned on when the ignition is turned and receives signals from the emergency vehicle transmitter to activate a warning light, message, and/or sound in the passenger vehicle.

Current technology used in mobile and stationary communications systems is used in both of the sub-systems or devices included in this system.

In the first model of the transmitting device, a stand-alone transmitter is carried in the emergency vehicle and is either manually switched on or wired into the circuit which is activated when the emergency light and/or siren is turned on. The transmitter in the second model is integrated into the built-in radio system of emergency vehicles and it would be best for all police, fire, and other emergency vehicles be so equipped.

The first model of the receiving device is a stand-alone radio receiver carried in the non-emergency vehicle and manually switched on. The second model is integrated with the vehicle's sound system and is switched on when the ignition is switched on and it would be best if all vehicles come equipped with the receiver whether it is integrated or not.

What is claimed is:

1. An emergency vehicle proximity warning system comprising:
a fixed frequency low wattage radio transmitter carried in emergency vehicles;
a radio receiver on the same fixed frequency picking up the signal transmitted by the emergency vehicle and providing an audible and/or visual warning that an emergency Vehicle is in close proximity.

2. The system as in claim 1 wherein the wattage may be varied manually.

3. The system as in claim 1 wherein the wattage may be varied automatically by the speed of the emergency vehicle.

4. The same as in claim 1 wherein the transmitter may be manufactured as an integral part of other electronic equipment.

5. The same as in claim 1 wherein the warning system receiver may be a stand-alone Device.

6. The same as in claim 5 wherein the receiver is not associated with a vehicle..

7. The same as in claim 1 wherein the warning system receiver may be integrated into other equipment.

8. The same as claim 7 wherein the receiver is not associated with a vehicle including but not limited to portable radios, telephones, pagers, headsets, eyeglasses, wristwatches and other devices.

9. The same as claim 1 wherein multiple frequencies may be included in both transmitting and receiving devices.

10. The same as in claim 1 wherein transmissions may originate from authorized sources other than emergency vehicles.
